(19) United States
(12) Patent Application Publication
(10) Pub. No.: US 2026/0280417 A1
(43) Pub. Date: Sep. 17, 2026

(54) SOFT-START CIRCUIT FOR VOLTAGE REGULATORS

(71) Applicant: Infineon Technologies AG, Neubiberg (DE)

(72) Inventors: Ionut-Alin ILIE, Bucharest (RO); Adrian-Gabriel BAJENARU, Bucharest (RO); Cristian Stefan ZEGHERU, Bucharest (RO)

(21) Appl. No.: 19/559,390

(22) Filed: Mar. 6, 2026

(30) Foreign Application Priority Data
Mar. 14, 2025 (DE) 102025109888.3

(51) Int. Cl. H02M 1/36; G05F 1/575; H02M 1/08; H02M 3/156

(52) U.S. Cl. CPC H02M 1/36; G05F 1/575; H02M 1/08; H02M 3/156

(57) ABSTRACT

In one embodiment, the voltage regulator circuit includes an input node for receiving an input voltage; an output node for providing an output voltage; a regulating element arranged between the input node and the output node; a controller circuit configured to drive a control electrode of the regulating element based on a difference between a reference voltage and a feedback voltage; and a feedback circuit that is configured to provide the feedback-voltage, wherein the feedback-voltage is a fraction of the output voltage plus a time-variable offset voltage.

### TECHNICAL FIELD

The present disclosure relates to the field of analog circuit design, in particular to a voltage regulator.

### BACKGROUND

Voltage regulators are used in a large variety of applications, for example, in so-called power management units (PMUs) and power management Integrated Circuits (PMICs). Generally, a linear regulator is a voltage regulator used to maintain a steady output voltage. The output voltage may be adjusted by a controllable resistance that may be implemented, for example, by a field effect transistor (FET). As control loop may adjust the resistance of the FET in such a way that the output voltage equals a defined reference voltage (set-point voltage).

A similar concept may be used for output voltage regulation in switching converters (e.g. buck converters or boost converters). In this case, a control loop may adjust the switching operation of a transistor (or a transistor halve-bridge), which is connected to an inductor, in such a way that the output voltage equals a defined reference voltage (set-point voltage).

During a transient start-up phase overshoots and other stability issues may occur due to the output voltage feedback. There is a need for an improved circuit design which allows a soft start of (linear or switching) voltage regulators.

### SUMMARY

A voltage regulator circuit with a voltage feedback circuit is described herein which is configured to provide a feedback-voltage which represents the output voltage plus a time-variable offset voltage.

In one embodiment, the voltage regulator circuit includes an input node for receiving an input voltage; an output node for providing an output voltage; a transistor arranged between the input node and the output node; and an error amplifier configured to drive a control electrode of the transistor based on a difference between a reference voltage and a feedback voltage. The feedback-voltage is provided by the feedback circuit, and the feedback-voltage is a fraction of the output voltage plus a time-variable offset voltage.

In one embodiment, the voltage regulator circuit includes an input node for receiving an input voltage; an output node for providing an output voltage; a regulating element arranged between the input node and the output node; and a controller circuit configured to drive a control electrode of the regulating element based on a difference between a reference voltage and a feedback voltage. The feedback-voltage is provided by the feedback circuit, and the feedback-voltage is a fraction of the output voltage plus a time-variable offset voltage.

### BRIEF DESCRIPTION OF THE DRAWINGS

The invention can be better understood with reference to the following drawings and descriptions. The components in the figures are not necessarily to scale; instead emphasis is placed upon illustrating the principles of the invention. Moreover, in the figures, like reference numerals designate corresponding parts. In the drawings:

FIG. 1 illustrates a general example of a linear voltage regulator.

FIG. 2 illustrates one example of a linear voltage regulator with a soft-start function.

FIG. 3 includes timing diagrams for illustrating the function of the circuit of FIG. 2.

FIG. 4 illustrates one example of a switching voltage regulator (buck converter) with a soft-start function.

FIG. 5 illustrates one exemplary implementation of the example of FIG. 2 in more detail.

FIG. 6 illustrates a further example, in which a voltage source is used instead of a current source.

### DETAILED DESCRIPTION

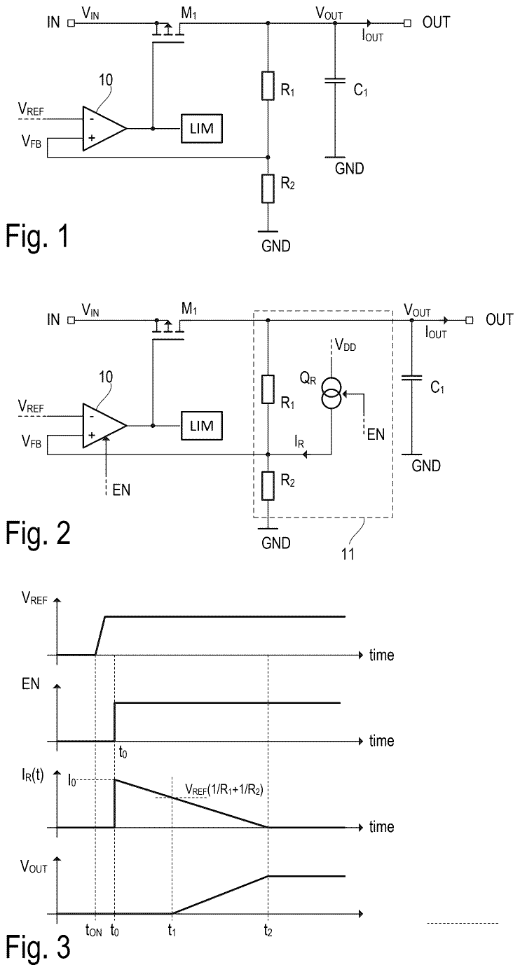

FIG. 1 illustrates a general example of a linear voltage regulator. It is understood that the depicted circuit is a simplified example wherein only those components are shown which are needed for the following discussion. According to FIG. 1, the circuit includes an input node IN for receiving an input voltage V_{IN} and an output node OUT for providing an output voltage V_{OUT}. A transistor M₁ is arranged between the input node IN and the output node OUT. An error amplifier 10 is configured drive a control electrode of the transistor M₁ based on a difference between a reference voltage V_{REF} and a feedback voltage V_{FB} that is provided by a feedback circuit 11 which is configured to provide, as feedback-voltage V_{FB} a fraction of the output voltage V_{OUT}. In the depicted example, the feedback circuit 11 is a simple resistive voltage divider composed of resistors R₁ and R₂ coupled in series between the output node OUT and ground potential GND. The feedback voltage V_{FB} is tapped at the middle tap of the voltage divider. Therefore, the mentioned fraction is R₂/(R₁+R₂) in the depicted example. It is understood, that the fraction may also be one (1/1) in some specific embodiments.

In steady state, the feedback voltage V_{FB} is approximately equal to the reference voltage. That is, V_{FB}=V_{REF}=V_{OUT}·R₂/(R₁+R₂), and the output voltage V_{OUT} equals V_{REF}·(1+R₁/R₂).

The circuit block labelled “LIM” symbolizes a protection circuit which may be configured to provide a current limiting function. Various implementations of current limiting circuits are known as such and will therefore not be discussed further herein. During a transient start-up phase, overshoots in the output voltage signal V_{OUT} and other stability issues may occur due to output voltage feedback.

FIG. 2 illustrates an enhancement of the circuit of FIG. 1 by adding circuitry which implements a kind of soft-start function. In essence, this additional circuitry affects the feedback voltage V_{FB} so that it is essentially a superposition of a first component that represents the output voltage V_{OUT} and a second components that is a time-variable offset voltage ΔV. In the depicted example, the time variable offset voltage ΔV(t) is generated by injecting a time-variable current I_{R} into the middle tap of the voltage divider (resistors R₁, R₂). In this example the offset voltage ΔV equals I_{R}R₁R₂/(R₁+R₂), and the feedback voltage V_{FB} equals V_{OUT}·R₂/(R₁+R₂)+ΔV=V_{OUT,0}+ΔV.

It is noted that the implementation of the feedback circuit 11 as shown in FIG. 2 is merely one specific example. A skilled person will be able to conceive other implementations which provide substantially the same function. Dependent on the application, the voltage divider may have a division ratio of one (i.e. the ratio V_{FB}/V_{OUT}=1 when ΔV=0). This is the case if resistor R₂ is very large (theoretically infinity) as compared to resistor R₁. A resistance value R2→∞ would result in the following feedback voltage: V_{FB}=V_{OUT}+I_{R}R₁. In another embodiment the voltage divider may have more than two resistors and two (or more) intermediate taps, wherein the feedback voltage is tapped at one intermediate tap of the voltage divider, while the time-variable current I_{R} is injected into another intermediate tap of the voltage divider.

As mentioned, the time varying offset voltage ΔV is only non-zero during a startup phase of the voltage regulator. In the depicted example, the current I_{R}, which is injected in the middle tap of the voltage divider, is provided by a current source Q_{R} that is activated at a time instant t₀ by an enable signal EN. Exemplary waveforms of the reference voltage V_{REF}, the enable signal EN, the time-varying current I_{R} (which causes the offset ΔV), and the output voltage V_{OUT} are illustrated in the timing diagrams of FIG. 3. In the depicted example, the current source Q_{R} is supplied from an internal supply voltage V_{DD} which may be derived, for example, from the input voltage V_{IN}.

In the example of FIG. 3, the reference voltage V_{REF} (first, top, diagram) rises from zero to its target value V_{REF} as soon as the input voltage V_{IN} is applied at the input terminal IN at time instant t_{ON}. The reference voltage V_{REF} may be generated e.g. by a bandgap reference circuit or the like. In some embodiments, the activation of the reference voltage output may be controlled by a controller circuit (not shown in FIG. 2).

The second diagram of FIG. 3 illustrates an exemplary signal curve of the enable signal EN, which triggers the activation of the voltage regulator by a transition from a Low level to a High level (logic levels Low/High). The time instant, at which the enable signal EN transitions from Low to High level is denoted t₀. At this time instant, the time varying offset voltage ΔV is added to the feedback voltage V_{FB}. As, at time t₀, the output voltage V_{OUT} is still zero, the feedback voltage V_{FB} equals I_{R}(t)·R₁R₂/(R₁+R₂), wherein I_{R}(t) is a linearly falling current ramp starting at I₀ and falling to zero.

The current signal I_{R}(t) (current ramp) is illustrated in the third diagram of FIG. 3. Assuming that I₀·R₁R₂/(R₁+R₂)>V_{REF}, the operational amplifier 10 (see FIG. 2) will drive the transistor M₁ to a non-conducting state (at time t₀), and the output voltage V_{OUT} remains zero until the current signal I_{R}(t) reaches the threshold level V_{REF}·(1/R₁+1/R₂), which happens at time instant t₁ in the depicted example. At time instant t₁ the feedback voltage V_{FB}=ΔV=I_{R}(t)·R₁R₂/(R₁+R₂) equals the reference voltage V_{REF}. Once the current I_{R}(t) is lower than the threshold V_{REF}·(1/R₁+1/R₂) or, more generally, once the condition ΔV<V_{REF} is true, the operational amplifier 10 drives the transistor M₁ into a conducting state, thus providing an output voltage V_{OUT} greater than zero, wherein the output voltage V_{OUT} increases as the current I_{R}(t) (and thus the offset ΔV) decreases. After time t₁, the operational amplifier 10 drives the transistor M₁ such that V_{OUT}·R₂/(R₁+R₂)+ΔV=V_{REF}. As soon as the current I_{R}(t) (and thus the offset voltage ΔV) has dropped to zero, which happens at time t₂ in the depicted example, the output voltage V_{OUT} equals V_{REF}·(R₁+R₂)/R₂. The time t₂ is considered the end of the startup phase. After the startup phase, during normal operation, the offset voltage ΔV remains zero.

It is noted that the current ramp I_{R}(t) does not necessarily have a constant slope. However, in most embodiments the level of the current I_{R}(t) will fall monotonously from the initial value I₀ to zero. The same is true for the offset voltage ΔV which may monotonously (but not necessarily linearly) fall from an initial offset value to zero.

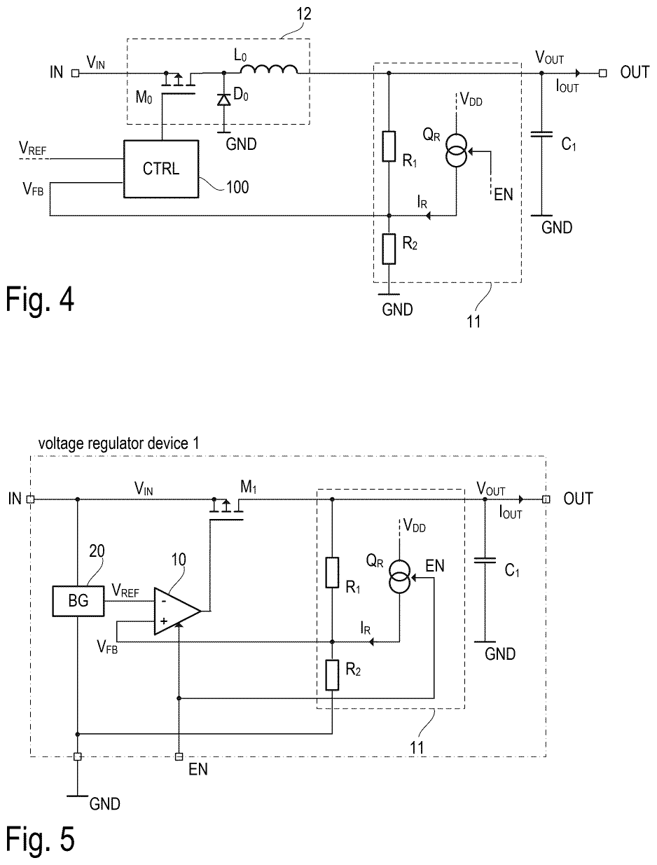

Although the “soft-start” concept described herein can be usefully applied in linear voltage regulators such as LDO (low drop-out) regulators, the concept can be readily applied to switching converters such as, for example buck converters, boost converters, flyback, converters or the like. FIG. 4 illustrates a buck converter, which uses a feedback circuit 11, which is constructed in the same way as in the example of FIG. 2.

To highlight the analogy between the examples of FIGS. 2 and 4, the example of FIG. 4 may be regarded as a modification of the example of FIG. 2, wherein the regulating transistor M₁ of FIG. 2 is replaced by a switching converter 12 (a buck converter in the depicted example) and the operational amplifier 10 of FIG. 2 is replaced by a switching controller 100 that controls the switching operation of the switching converter 12 based on a reference voltage V_{REF} and a feedback voltage V_{FB}.

In the depicted example, the switching converter 12 includes an electronic switch M₀ (which may be, for example, a MOS transistor) and an inductor L₀ which are connected in series between the input node IN and the output node OUT. A free-wheeling diode D₀ is connected between a ground node GND and the common circuit node of inductor L₀ and transistor M₀. In some embodiments, the diode D₀ can be replaced by a second transistor. As mentioned, the switching converter 12 forms a buck converter stage. Buck converters as well as other converter topologies (e.g. boost converters, flyback converters, etc.) are as such well-known in the technical field of switching converters and thus not discussed herein in more detail.

The switching controller 100 is configured to switch the transistor M₀ on and off in accordance with a specific switching scheme. Usually pulse-width modulated (PWM) or pulse-frequency modulated (PFM) drive signals are generated to switch the transistor M₀ on and off, wherein the on-timess and the off-times of the transistor M₀ are determined such that the feedback voltage V_{FB}, which represents the output voltage V_{OUT}, substantially equals the reference voltage V_{REF}. It is noted that various suitable concepts for controlling the switching operation of a switching converter stage (i.e. for generating PWM or PFM signals for driving the transistor M₀) are as such known and thus not further discussed herein in more detail.

It is noted that the feedback circuit 11 of FIG. 4 is the same as in the example of FIG. 2 and reference is made to the description above to avoid unnecessary reiterations. The signal curves of FIG. 3 and the respective explanations also apply to the circuit of FIG. 4. It is noted that the buck converter state 12 may be replaced by a boost converter state or another known converter topology.

FIG. 5 illustrates one exemplary implementation of the example of FIG. 2 in more detail. Accordingly, the voltage regulator is implemented in a packaged semiconductor chip 1, wherein the input node IN, the output node OUT as well as the ground node are connected with respective chip contacts (pins). In some examples (as shown in FIG. 5), the enable signal EN may be provided by an external circuit to a further chip contact. Furthermore, the reference voltage V_{REF} is a stabilized constant voltage provided by a band-gap reference circuit 20, which is supplied by the (e.g. unregulated) input voltage V_{IN}. All remaining components of the circuit of FIG. 5 are the same as shown in FIG. 2 and reference is made to the respective description above.

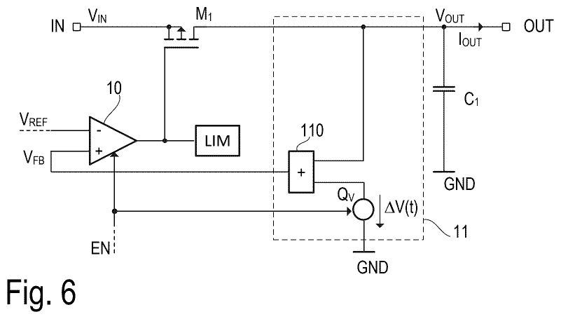

FIG. 6 illustrates a further exemplary implementation of the concept described herein. In the depicted example, the feedback circuit includes a controllable current source Q_{V} and an adder circuit 110. The controllable current source Q_{V} is configured to provide the time-variable offset voltage ΔV(t) and the adder circuit 110 is configured to provide, as feedback voltage V_{FB}, the sum of the time-variable offset voltage ΔV(t) and the output voltage V_{OUT}. In one specific implementation, the adder circuit 110 may be configured to provide, as feedback voltage V_{FB}, the weighted sum a·ΔV(t)+b·V_{OUT}, wherein a and b are constant parameters (weight factors). In one embodiment the factor b is lower than one (b<1) while a equals one (a=1). In one embodiment the weight factors a and b are equal (a=b).

It can be seen from FIGS. 2 and 6 that the circuits are equivalent in function if a=b=R₂/(R₁+R₂) and ΔV(t)=I_{R}(t)·R₁. In this case the following equation applies: V_{FB}=V_{OUT}·R₂/(R₁+R₂)+I_{R}(t)·R₁R₂/(R₁+R₂). It is understood that the timing diagrams of FIG. 3 essentially are also valid for the example of FIG. 6 provided that the current I_{R}(t) shown in the third (from the top) diagram of FIG. 3 is scaled by the parameter R₁ to obtain ΔV(t).

The embodiments described above are now summarized. It is emphasized that the following is not a complete list but rather a non-exhaustive, exemplary summary. The reference signs between parentheses refer to FIG. 2-6.
Example 1: A voltage regulator circuit comprising: an input node (IN) for receiving an input voltage (V_{IN}); an output node (OUT) for providing an output voltage (V_{OUT}); a transistor (M₁) arranged between the input node (IN) and the output node (OUT); an error amplifier (10) configured to drive a control electrode of the transistor (M₁) based on a difference between a reference voltage (V_{REF}); and a feedback voltage (V_{FB}), a feedback circuit (11) configured to provide the feedback-voltage (V_{FB}), wherein the feedback-voltage (V_{FB}) is a fraction (R₂/(R₁+R₂)) of the output voltage (V_{OUT}) plus a time-variable offset voltage (I_{R}R₁R₂/(R₁+R₂)).
Example 2: A voltage regulator circuit comprising: an input node (IN) for receiving an input voltage (V_{IN}); an output node (OUT) for providing an output voltage (V_{OUT}); a regulating element (12, M₁) arranged between the input node (IN) and the output node (OUT); a controller circuit (100, 10) configured to drive a control electrode of the regulating element (12, M₁) based on a difference between a reference voltage (V_{REF}) and a feedback voltage (V_{FB}); and a feedback circuit (11) configured to provide the feedback-voltage (V_{FB}), wherein the feedback-voltage (V_{FB}) is a fraction (R₂/(R₁+R₂)) of the output voltage (V_{OUT}) plus a time-variable offset voltage (I_{R}R₁R₂/(R₁+R₂)).
Example 3: The voltage regulator circuit of example 2, wherein the regulating element is a transistor (M₁) and the controller circuit (10) is an error amplifier.
Example 4: The voltage regulator circuit of example 2, wherein the regulating element is a switching converter (12) and the controller circuit is a switching controller (100) configured to control the switching operation of the switching converter (12).
Example 5: The voltage regulator of any of examples 1 to 4, wherein the feedback circuit (11) comprises: a voltage divider coupled between the output node (OUT) and a reference potential (GND), the voltage divider having a first middle tap at which the feedback voltage (V_{FB}) is provided; a current source (Q_{R}) configured to provide a time-variable current (I_{R}) to the first middle tap, or a second middle tap, wherein the current (I_{R}) is zero after a startup phase of the voltage regulator.
Example 6: The voltage regulator of example 5, wherein the voltage divider is composed of at least two resistors (R₁, R₂) and wherein the offset voltage (I_{R}R₁R₂/(R₁+R₂)) is caused by the variable current (I_{R}) changing voltage drops across the resistors (R₁, R₂) of the voltage divider.
Example 7: The voltage regulator of any of examples 1 to 6, wherein the reference voltage (V_{REF}) is set to a constant voltage upon activation of the voltage regulator.
Example 8: The voltage regulator of any of examples 1 to 7, wherein the feedback circuit (11) is configured to set the offset voltage (I_{R}R₁R₂/(R₁+R₂)) to an initial value at a first time instant (t₀) and to reduce the offset voltage until the offset voltage reaches zero at a second time instant (t₂).
Example 9: The voltage regulator of any of examples 1 to 8, wherein the reference voltage (V_{REF}) is set to a constant voltage upon activation of the voltage regulator; wherein the feedback circuit (11) is configured to set the offset voltage (I_{R}R₁R₂/(R₁+R₂)) to an initial value at a first time instant (t₀), after the activation, and to reduce the offset voltage until the offset voltage reaches zero at a second time instant (t₂).
Example 10: The voltage regulator of example 8 or 9, wherein the offset voltage is reduced with a monotonic slope.
Example 11: The voltage regulator of example 8 or 9, wherein the first time instant (t₀) is determined by an enable signal (EN).
Example 12: The voltage regulator of example 11, wherein the enable signal is received at a chip pin of the voltage regulator.
Example 13: A method for operating a voltage controller during startup, the method comprising generating a regulated output voltage (V_{OUT}) from an input voltage using a regulating element (12, M₁), wherein generating the regulated output voltage (V_{OUT}) includes: [i] generating a feedback voltage (V_{FB}) that is a fraction (R₂/(R₁+R₂)) of the output voltage (V_{OUT}) plus a time-variable offset voltage (I_{R}R₁R₂/(R₁+R₂)); and [ii] driving a control electrode of the regulating element (12, M₁) based on a difference of a reference voltage (V_{REF}) and the feedback voltage (V_{FB}).
Example 14: The method of example 13, further comprising: setting the reference voltage (V_{REF}) to a constant voltage upon activation of the voltage regulator.
Example 15: The method of example 14, wherein generating the feedback voltage (V_{FB}) includes: setting the offset voltage (I_{R}R₁R₂/(R₁+R₂)) to an initial value at a first time instant (t₀), after activation, and reducing the offset voltage until the offset voltage reaches zero at a second time instant (t₂).
Example 16: The method of any of examples 13 to 15, wherein generating the feedback voltage (V_{FB}) includes: [i] generating a time-variable current (I_{R}); [ii] injecting the time-variable current (I_{R}) at a middle tap of a voltage divider that receives the output voltage (V_{OUT}), wherein the current (I_{R}) is zero after a startup-phase of the voltage divider.
Example 17: The method of example 16, wherein the regulating element is a transistor (M₁) or a switching converter (12).

Although the invention has been illustrated and described with respect to one or more implementations, alterations and/or modifications may be made to the illustrated examples without departing from the spirit and scope of the appended claims. In particular regard to the various functions performed by the above described components or structures (units, assemblies, devices, circuits, systems, etc.), the terms (including a reference to a “means”) used to describe such components are intended to correspond—unless otherwise indicated—to any component or structure, which performs the specified function of the described component (e.g., that is functionally equivalent), even though not structurally equivalent to the disclosed structure, which performs the function in the herein illustrated exemplary implementations of the invention.

1. A voltage regulator circuit comprising:
an input node (IN) for receiving an input voltage (V_{IN});
an output node (OUT) for providing an output voltage (V_{OUT});
a regulating element arranged between the input node (IN) and the output node (OUT);
an error amplifier configured to drive a control electrode of the transistor based on a difference between a reference voltage (V_{REF}) and a feedback voltage (V_{FB}); and
a feedback circuit configured to provide the feedback-voltage (V_{FB}), wherein the feedback-voltage (V_{FB}) is a fraction (R₂/(R₁+R₂)) of the output voltage (V_{OUT}) plus a time-variable offset voltage (I_{R}R₁R₂/(R₁+R₂)).

2. The voltage regulator circuit of claim 1, further comprising:
a controller circuit configured to drive a control electrode of the regulating element based on a difference between a reference voltage (V_{REF}) and a feedback voltage (V_{FB}).

3. The voltage regulator circuit of claim 2,
wherein the regulating element is a transistor and the controller circuit is an error amplifier.

4. The voltage regulator circuit of claim 2,
wherein the regulating element is a switching converter and the controller circuit is a switching controller configured to control the switching operation of the switching converter.

5. The voltage regulator of claim 1, wherein the feedback circuit comprises:
a voltage divider coupled between the output node (OUT) and a reference potential (GND), the voltage divider having a first middle tap at which the feedback voltage (V_{FB}) is provided;
a current source (Q_{R}) configured to provide a time-variable current (I_{R}) to the first middle tap, or a second middle tap, wherein the current (I_{R}) is zero after a startup phase of the voltage regulator.

6. The voltage regulator of claim 5,
wherein the voltage divider is composed of at least two resistors (R₁, R₂) and wherein the offset voltage (I_{R}R₁R₂/(R₁+R₂)) is caused by the variable current (I_{R}) changing voltage drops across the resistors (R₁, R₂) of the voltage divider.

7. The voltage regulator of claim 1,
wherein the reference voltage (V_{REF}) is set to a constant voltage upon activation of the voltage regulator.

8. The voltage regulator of claim 1,
wherein the feedback circuit is configured to set the offset voltage (I_{R}R₁R₂/(R₁+R₂)) to an initial value at a first time instant (t₀) and to reduce the offset voltage until the offset voltage reaches zero at a second time instant (t₂).

9. The voltage regulator of claim 1,
wherein the reference voltage (V_{REF}) is set to a constant voltage upon activation of the voltage regulator;
wherein the feedback circuit is configured to set the offset voltage (I_{R}R₁R₂/(R₁+R₂)) to an initial value at a first time instant (t₀), after the activation, and to reduce the offset voltage until the offset voltage reaches zero at a second time instant (t₂).

10. The voltage regulator of claim 9,
wherein the offset voltage is reduced with a monotonic slope.

11. The voltage regulator of claim 9,
wherein the first time instant (t₀) is determined by an enable signal (EN).

12. The voltage regulator of claim 11,
wherein the enable signal is received at a chip pin of the voltage regulator.

13. A method for operating a voltage controller during startup, the method comprising:
generating a regulated output voltage (V_{OUT}) from an input voltage using a regulating element,
wherein generating the regulated output voltage (V_{OUT}) includes:
generating a feedback voltage (V_{FB}) that is a fraction (R₂/(R₁+R₂)) of the output voltage (V_{OUT}) plus a time-variable offset voltage (I_{R}R₁R₂/(R₁+R₂)); and
driving a control electrode of the regulating element based on a difference of a reference voltage (V_{REF}) and the feedback voltage (V_{FB}).

14. The method of claim 13, further comprising:
setting the reference voltage (V_{REF}) to a constant voltage upon activation of the voltage regulator.

15. The method of claim 14, wherein generating the feedback voltage (V_{FB}) includes:
setting the offset voltage (I_{R}R₁R₂/(R₁+R₂)) to an initial value at a first time instant (t₀), after activation, and reducing the offset voltage until the offset voltage reaches zero at a second time instant (t₂).

16. The method of claim 13, wherein generating the feedback voltage (V_{FB}) includes:
generating a time-variable current (I_{R});
injecting the time-variable current (I_{R}) at a middle tap of a voltage divider that receives the output voltage (V_{OUT}), wherein the current (I_{R}) is zero after a startup-phase of the voltage divider.

17. The method of claim 16, wherein the regulating element is a transistor or a switching converter.
